(19) United States
(12) Patent Application Publication
(10) Pub. No.: US 2009/0063954 A1
(43) Pub. Date: Mar. 5, 2009

(54) STRUCTURED DOCUMENT PROCESSING APPARATUS AND STRUCTURED DOCUMENT PROCESSING METHOD

(75) Inventor: Wataru Shimizu, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/196,565

(22) Filed: Aug. 22, 2008

(30) Foreign Application Priority Data
Aug. 31, 2007 (JP) 2007-226694

(51) Int. Cl. G06F 17/00

(52) U.S. Cl. 715/234

(57) ABSTRACT

An XML document is parsed using one of a text XML parser (105) and binary XML parser (106) according to the format of the XML document. A helper application (111) accepts a request to acquire an element described in the XML element to have a designated type. When the parsed type matches the designated type, the helper application (111) outputs the element to a request source; otherwise, it converts the type of the element into the designated type, and then outputs the element to the request source.

### BACKGROUND OF THE INVENTION

1. Field of the Invention

The present invention relates to a technique for processing a structured document.

2. Description of the Related Art

Nowadays, XML (Extensible Markup Language: http://www.w3.org/TR/2004/REC-xml-20040204/) is used as the format of various data to be handled on computers. XML has a feature in that it does not depend on computers, operating systems, and the like. Hence, XML has been widely distributed especially as communication data on networks since it allows easy communications among different types of computers and devices on the networks.

In recent years, networking of various devices such as mobile phones, copying machines, digital cameras, and the like other than personal computers and servers has progressed. For this reason, these devices increasingly handle XML.

Under such circumstances, the processing speed and efficiency of XML pose serious problems. Since XML does not have a format that gives priority to improvement of the processing speed, it takes much time to parse. Since the description of XML has redundancy, it requires a large data size. These problems are serious in compact devices which have low processing speeds and small memory resources. Even in devices such as servers and the like having large resources, upon processing a very large number of XML documents, the parsing time of XML poses a serious problem.

For these reasons, a format which is semantically equivalent to the XML format and allows more efficient processing has come into use. Such a format is generally called “binary XML”. Note that XML in the text format according to the XML specification is called “text XML” in this specification.

Binary XML has not one but several format specifications. Many formats have been conceived to attain a size reduction and improvement of processing efficiency by eliminating the redundancy and executing encodings according to data types.

Elimination of the redundancy is to omit end tag names, and to replace character strings such as element names, attribute names, attribute values, and the like, which appear frequently, by integers. Since each end tag must have the same name as a start tag described immediately before the end tag, the end tag name can be omitted. For example, in an XHTML document including many images, a character string “img” appears frequently. By replacing these frequent character strings by integers that are as small as possible, the document size is reduced.

Encodings according to data types are to change an encoding method for the contents of elements, attribute values, and the like in accordance with their types (integer type, floating type, date type, and so forth). For example, in text XML, even when “12345” in an element <x>12345</x>represents an integer “12345”, it is described as a character string “12345” in a document. Hence, if the character encoding of a document is UTF-8, the above value is encoded to data “0x30, 0x31, 0x32, 0x33, 0x45”.

In this manner, since the format described in an XML document is different from that to be handled inside a computer, format conversion is required upon reading the XML document and processing it inside the computer. For example, when an integer is handled as big-endian ordered 4 bytes inside a certain structured document processing apparatus, an integer “12345” is converted into a byte string “0x00, 0x00, 0x30, 0x2E”. Such type conversion requires much time particularly in the case of floats.

By contrast, binary XML describes integers and float values in the same format as that to be handled inside a computer. For this reason, no format conversion is required, and processing can be sped up.

As an example of attaining elimination of the redundancy and encodings according to data types based on indexing, Fast Infoset (ITU-T Rec. X.8911|ISO/IEC24824-1) is available.

Upon handling binary XML, it is a common practice to use a parser dedicated to binary XML data (to be referred to as a binary XML parser hereinafter). The binary XML parser normally has the same interface as that of a text XML parser. This is because the use of the same interface allows an application that uses the text XML parser to cope with the binary XML parser without altering the application. As the binary XML parser having the same interface as the text XML parser, a parser of Fast Infoset Project of Sun Microsystems Inc. is available.

Patent reference 1 describes that both XML data and legacy file data undergo data conversion so that both a system that uses XML data and a system that uses legacy file data can process data.

[Patent Reference 1] Japanese Patent Laid-Open No. 2004-318420

However, the binary XML parser having the same interface as the text XML parser cannot exploit the merits of the binary XML format that executes encodings according to data types.

This is because since the interface of the text XML parser exchanges all data as those of a string type, if the same interface is used, data of the string type can only be handled. For this reason, even when a binary XML document includes float data in an IEEE754 format, wasteful conversions are required, that is, the binary XML parser converts that data into data of a string type and passes it to an application, and the application re-converts that data into the IEEE754 format.

If the interface of the binary XML parser is different from that of the text XML parser, an application for the binary XML parser cannot handle the text XML parser. That is, that application cannot support text XML documents, thus posing another problem.

### SUMMARY OF THE INVENTION

The present invention has been made in consideration of the aforementioned problems, and has as its object to provide a technique that allows a single application to handle XML documents of a plurality of types of formats.

It is another object of the present invention to provide a technique for efficiently handing binary XML documents described by encodings according to data types.

According to the first aspect of the present invention, there is provided a structured document processing apparatus for processing a structured document, comprising: an acquisition unit which acquires a format of a structured document; a parsing unit which parses the structured document by a parsing method according to the format acquired by the acquisition unit; a unit which accepts a request of acquiring an element described in the structured document to have a designated type; a determination unit which determines whether or not a type of the element parsed by the parsing unit matches the designated type; and an output unit which outputs the element to a request source when the determination unit determines a match, and outputs the element to the request source after the type of the element is converted to the designated type when the determination unit determines a mismatch.

According to the second aspect of the present invention, there is provided a structured document processing method to be executed by a structured document processing apparatus for processing a structured document, comprising: an acquisition step of acquiring a format of a structured document; a parsing step of parsing the structured document by a parsing method according to the format acquired in the acquisition step; a step of accepting a request of acquiring an element described in the structured document to have a designated type; a determination step of determining whether or not a type of the element parsed in the parsing step matches the designated type; and an output step of outputting the element to a request source when a match is determined in the determination step, and outputting the element to the request source after the type of the element is converted to the designated type when a mismatch is determined in the determination step.

Further features of the present invention will become apparent from the following description of exemplary embodiments with reference to the attached drawings.

### BRIEF DESCRIPTION OF THE DRAWINGS

FIG. 1 is a block diagram showing an example of the hardware arrangement of a computer which can be applied to a structured document processing apparatus according to the first embodiment of the present invention;

FIG. 2 is a diagram showing an example of the configuration of a network to which a computer 100 is applied;

FIG. 3 is a table showing an example of APIs of a text XML parser 105;

FIG. 4 is a table showing an example of APIs of a binary XML parser 106;

FIG. 5 is a table showing an example of APIs of a common XML parser 109;

FIG. 6 is a view showing a configuration example of an XML document as an object to be processed by the computer 100;

FIG. 7 is a view showing a configuration example of an XML document as an object to be processed by the computer 100;

FIG. 8 is a flowchart of processing implemented when a CPU 101 executes a program of a helper application 111;

FIG. 9 is a flowchart of processing which starts simultaneously with execution of the process in step S802;

FIG. 10 is a flowchart showing details of the processes in steps S805 and S807;

FIG. 11 is a flowchart of processing executed by the computer 100 when a legacy application 110 handles personal information data;

FIG. 12 is a block diagram showing the hardware arrangement of a computer 1200 which can be applied to a structured document processing apparatus according to the second embodiment of the present invention;

FIG. 13 is a view showing a configuration example when an XML document shown in FIG. 14 is expressed in a Fast Infoset format;

FIG. 14 is a view showing a configuration example of a text XML document; and

FIG. 15 is a flowchart of processing executed by the computer 1200 when a helper application 111 acquires a value of a element shown in FIG. 13.

### DESCRIPTION OF THE EMBODIMENTS

Preferred embodiments of the present invention will be described in detail hereinafter with reference to the accompanying drawings. Note these embodiments will be explained as examples of preferred arrangements of the invention described in the scope of claims, and that invention is not limited to the embodiments to be described hereinafter.

### First Embodiment

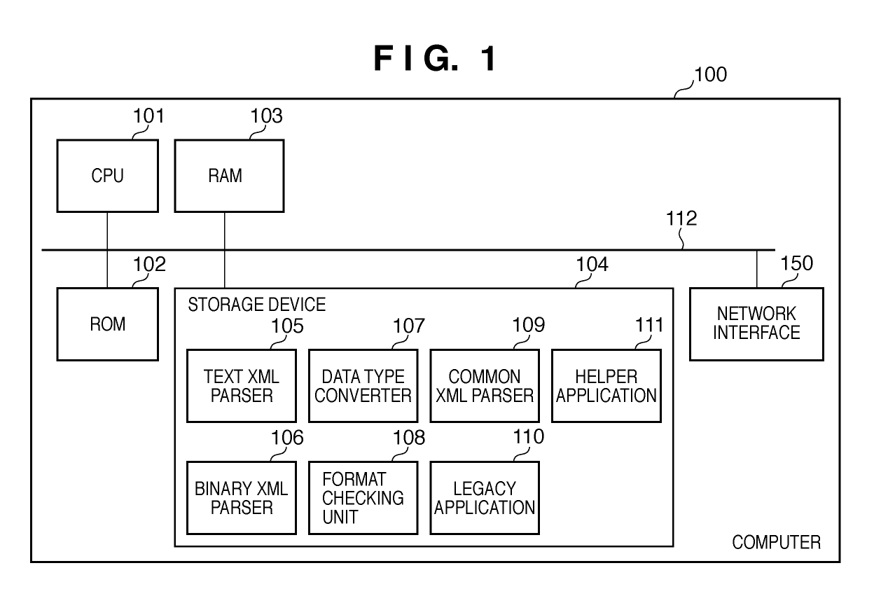

FIG. 1 is a block diagram showing an example of the hardware arrangement of a computer which can be applied to a structured document processing apparatus according to this embodiment. Note that the arrangement of an apparatus which can be applied to the structured document processing apparatus according to this embodiment is not limited to that shown in FIG. 1, and various modifications will occur to those who are skilled in the art. Furthermore, the present invention is not limited to the structured document processing apparatus according to this embodiment, which is implemented by a single apparatus, but it may be implemented by the collaboration of a plurality of apparatuses. In this case, the plurality of apparatuses is connected via a network such as a LAN or the like.

Referring to FIG. 1, a CPU 101 controls a whole computer 100 using programs and data stored in a ROM 102 and RAM 103, and executes respective processes to be described later, which will be explained as those to be implemented by the computer 100.

The ROM 102 stores setting data and a boot program of the computer 100, data of parameters which need not be changed, and the like.

The RAM 103 has an area used to temporarily store programs and data loaded from a storage device 104, data externally received via a network interface 150, and the like. Furthermore, the RAM 103 also has a work area used when the CPU 101 executes various processes.

The storage device 104 is a large-capacity information storage device represented by a hard disk drive device. The storage device 104 saves an OS (operating system), programs and data which make the CPU 101 execute respective processes to be described later, which will be described as those to be implemented by the computer 100. The storage device 104 saves, as files, data of XML documents as structured documents to be processed (to be described later). The programs and data saved in the storage device 104 are loaded onto the RAM 103 as needed under the control of the CPU 101, and are to be processed by the CPU 101.

Software programs saved in the storage device 104 will be described below.

Upon reception of a parsing request of an XML document in the text format (to be referred to as a text XML document hereinafter), a text XML parser 105 executes parsing processing of this XML document, and returns the parsed result.

Upon reception of a parsing request of an XML document in the binary format (to be referred to as a binary XML document hereinafter), a binary XML parser 106 executes parsing processing of this XML document, and returns the parsed result.

When three parameters, that is, the type of data before conversion, that of data after conversion, and data to be converted are designated, a data type converter 107 converts the type of data to be converted into that after conversion, and returns the converted data.

A format checking unit 108 checks the format of given data.

A common XML parser 109 implements parsing processing of a text XML document and binary XML document by selectively using the text XML parser 105 and binary XML parser 106.

A legacy application 110 executes processing using APIs (Application Programming Interfaces) of the text XML parser 105.

A helper application 111 executes processing using APIs of the common XML parser 109. Both the legacy application 110 and helper application 111 function as services that process XML documents received from a network.

Note that processes to be implemented by the software programs described as those saved in the storage device 104 will be described later.

The network interface 150 is used to connect the computer 100 to a LAN, the Internet, or the like. The computer 100 can make data communications with external devices via this network interface 150.

Reference numeral 112 denotes a bus which interconnects the aforementioned units.

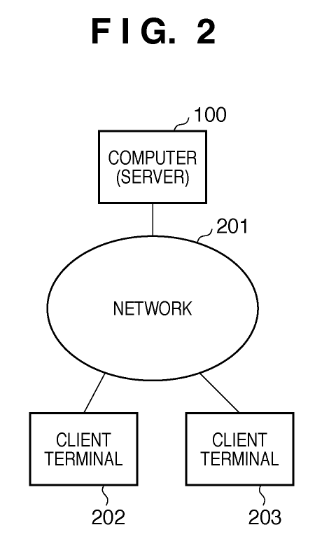

FIG. 2 is a diagram showing a configuration example of a network to which the computer 100 is applied.

As shown in FIG. 2, the computer 100 is connected as a server to a network 201. The network 201 is configured by a LAN, the Internet, or the like. Reference numerals 202 and 203 denote client terminals, which are connected to the network 201.

Assume that the client terminal 202 generates a binary XML document, and transmits the generated binary XML document to the computer 100. On the other hand, assume that the client terminal 203 generates a text XML document, and transmits the generated text XML document to the computer 100.

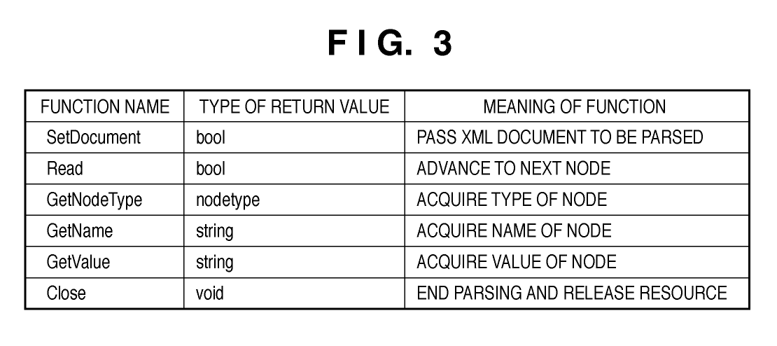

The APIs of the text XML parser 105 will be described below with reference to FIG. 3. FIG. 3 shows an example of the APIs of the text XML parser 105.

“SetDocument” is a function used to open an XML document to be parsed.

“Read” is a function used to read the XML document to be parsed from its start position by one node. Note that the node is a unit that configures an XML document, and includes a start tag (StartElement), end tag (EndElement), contents (Content) of elements, and the like.

“GetNodeType” is a function used to return a type (node type) of a currently referred node, and returns a value such as “StartElement”, “EndElement”, or the like.

“GetName” is a function used to return the name of the currently referred node. That is, when the currently referred node is a start tag, that function returns the tag name of the start tag.

“GetValue” is a function used to return the value of the currently referred node. That is, when the currently referred node is “Content”, that function returns the contents of the element. Since all contents of a text XML document are described in the text format, the return value of “GetValue” is also of a string type.

“Close” is a function used to end the parsing processing, and to release assured memory resources and the like.

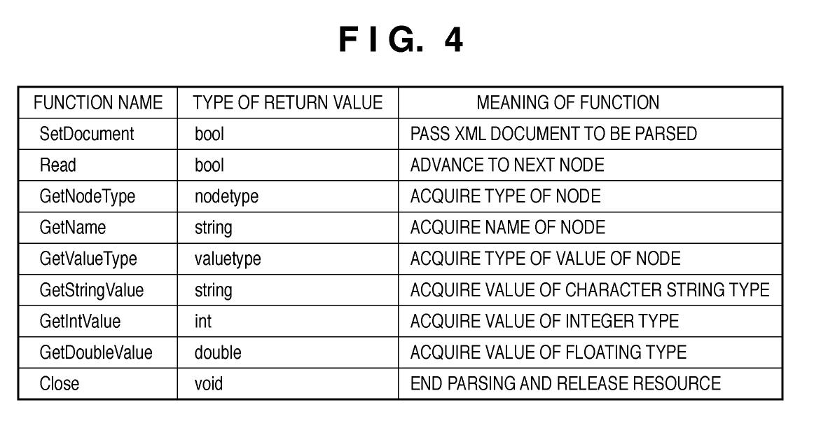

The APIs of the binary XML parser 106 will be described below with reference to FIG. 4. FIG. 4 is a table showing an example of the APIs of the binary XML parser 106.

Functions “SetDocument”, “Read”, “GetNodeType”, “GetName”, and “Close” are the same as those shown in FIG. 3, and their explanations are also as described above. That is, these functions play the same roles as the APIs of the same names of the text XML parser 105. However, functions used to acquire node values of the binary XML parser 106 are largely different from those of the text XML parser 105.

“GetValueType” is a function used to return the type of a value of a currently referred node. For example, when the value of the currently referred node is described as an integer value in a binary XML document, this function returns “int”; when it is described as a float, the function returns “double”.

“GetStringValue” is a function used to acquire the value of a currently referred node of the string type.

“GetIntValue” is a function used to acquire the value of a currently referred node of the integer type.

“GetDoubleValue” is a function used to acquire the value of a currently referred node of the floating type.

That is, each API of the binary XML parser 106 returns the value of the currently referred node to have a type described in the XML document.

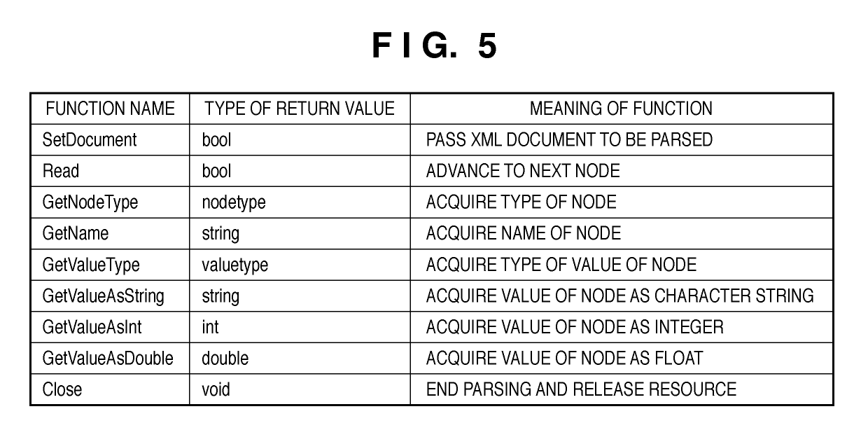

The APIs of the common XML parser 109 will be described below with reference to FIG. 5. FIG. 5 is a table showing an example of the APIs of the common XML parser 109.

Functions “SetDocument”, “Read”, “GetNodeType”, “GetName”, and “Close” are the same as those shown in FIG. 3, and their explanations are also as described above. That is, these functions play the same roles as the APIs of the same names of the text XML parser 105 and binary XML parser 106.

“GetValueAsString” is a function used to acquire the value of a currently referred node as a character string.

“GetValueAsInt” is a function used to acquire the value of the currently referred node as an integer.

“GetValueAsDouble” is a function used to acquire the value of the currently referred node as that of the floating type.

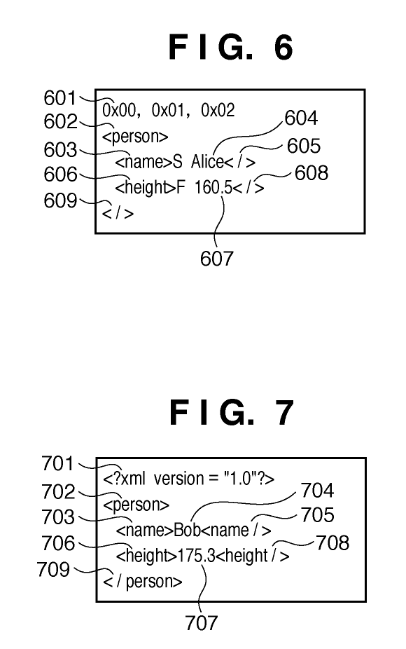

The operation of the computer 100 when an XML document with the configuration exemplified in FIG. 6 is to be processed will be described below. FIG. 6 is a view showing a configuration example of an XML document to be processed by the computer 100. The XML document with the configuration shown in FIG. 6 is personal information data which stores the name (name) and height (height) of a person.

A start tag is bounded by “<” and “>” . In FIG. 6, tags 602, 603, and 606 correspond to start tags.

“</>” represents an end tag. In FIG. 6, tags 605, 608, and 609 correspond to end tags.

Content parts 604 and 607 of elements start with symbols “S” and “F”, and actual values are described after these symbols. “S” at the head of the content part 604 indicates that the subsequent value is a character string described in UTF-8. “F” indicates that the subsequent value is described in a 4-byte floating format of the IEEE754 format.

The IEEE754 format is the same format as the floating type to be handled by an application. A head part in the XML document, that is, a part 601, is called a magic number. By checking several bytes near the head of the XML document, the format of this XML document can be identified. In this embodiment, in order to indicate that an XML document is a binary XML document, a character string “0x01, 0x02, 0x03” is used as the magic number 601.

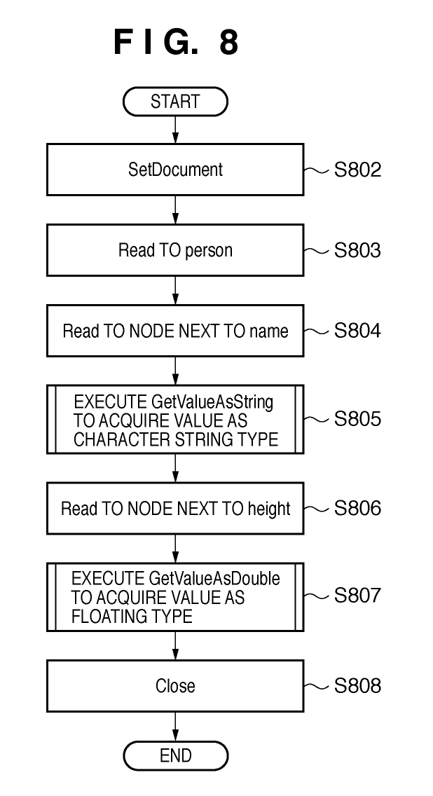

Processing to be executed by the computer 100 after the data of the XML document shown in FIG. 6 is loaded from the storage device 104 onto the RAM 103 will be described below with reference to FIG. 8. FIG. 8 is a flowchart of processing implemented when the CPU 101 executes a program of the helper application 111. This processing acquires the name and height from the XML document shown in FIG. 6, that is, personal information data as a character string and integer.

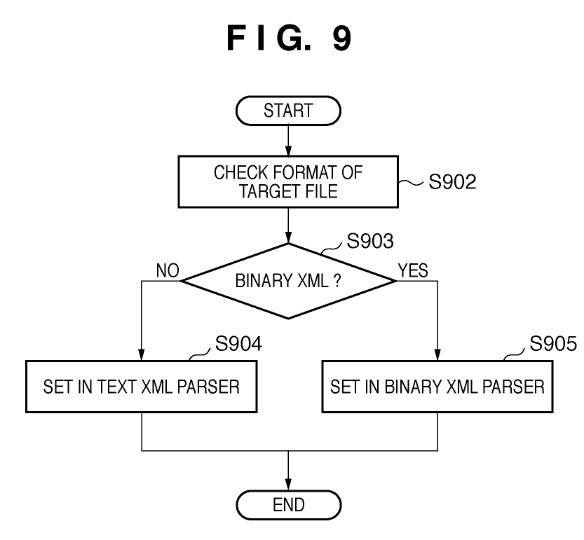

In step S802, the CPU 101 executes the function “SetDocument” to open the XML document shown in FIG. 6. Upon execution of the process in step S802, the processing according to the flowchart shown in FIG. 9 starts. The flowchart of FIG. 9 will be described later.

In step S803, the CPU 101 executes the function “Read” to confirm that the first start tag is “person”, and executes the functions “GetNodeType” and “GetName” with respect to the current reference position advanced by that execution. The CPU 101 repetitively executes the function “Read” until the return value of the function “GetNodeType” is a start tag, and that of the function “GetName” is “person”.

In step S804, the CPU 101 executes the function “Read”, and executes the functions “GetNodeType” and “GetName” with respect to the current reference position advanced by that execution. The CPU 101 repetitively executes the function “Read” until the return value of the function “GetNodeType” is a “name” tag, and that of the function “GetName” is “name”.

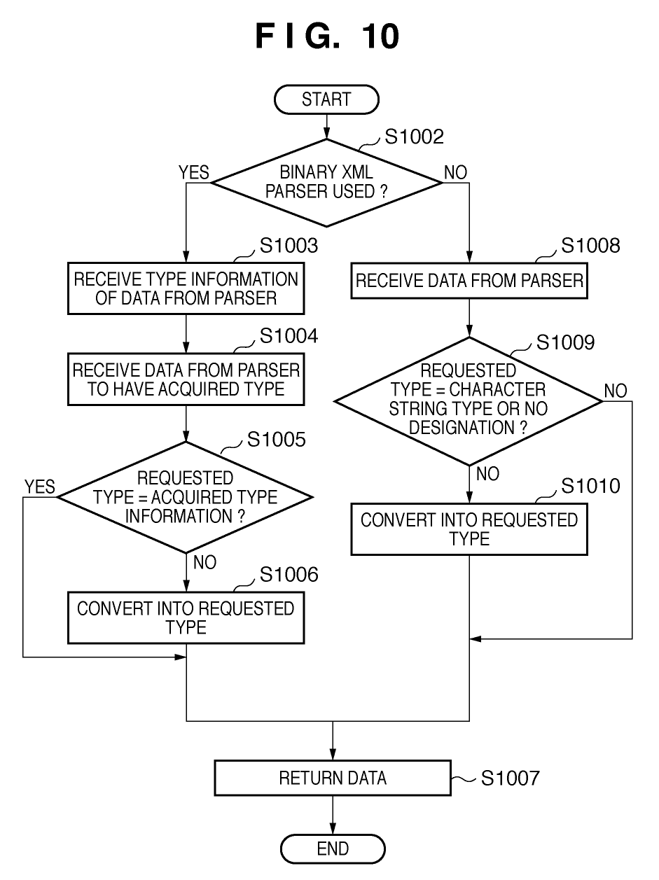

In step S805, the CPU 101 executes “GetValueAsString” to acquire the contents of the “name” tag (element), that is, “Alice” as a character string. Details of the process in step S805 will be described later using FIG. 10.

In step S806, the CPU 101 executes the function “Read”, and executes the functions “GetNodeType” and “GetName” with respect to the current reference position advanced by that execution. The CPU 101 repetitively executes the function “Read” until the return value of the function “GetNodeType” is a “height” tag, and that of the function “GetName” is “height”.

In step S807, the CPU 101 executes the function “GetValueAsDouble” to acquire the contents of the “height” tag (element), that is, “160.5” as a value of the floating type. Details of the process in step S807 will be described later using FIG. 10.

In step S808, the CPU 101 executes the function “Close” to release memory resources and the like of the RAM 103.

The processing which starts simultaneously with execution of the process in step S802 above will be described below with reference to FIG. 9 which shows the flowchart of that processing. The processing according to the flowchart of FIG. 9 is implemented when the CPU 101 executes a program of the common XML parser 109.

In step S902, the CPU 101 executes the format checking unit 108 to make it acquire a magic number (the magnetic number 601 in FIG. 6) in the XML document opened in step S802. The common XML parser 109 acquires the magic number acquired by the format checking unit 108. The common XML parser 109 checks the format of the XML document using the acquired magic number. That is, the common XML parser 109 checks if the XML document is a text or binary XML document.

In this checking process, if the magic number starts with a character string “<?”, the common XML parser 109 determines that the XML document is a text XML document; if it starts with a character string “0x01, 0x02, 0x03”, the common XML parser 109 determines that the XML document is a binary XML document. The XML document shown in FIG. 6 is determined as a binary XML document.

However, the method of checking the format of an XML document is not limited to this, and various other methods may be used. For example, the format may be checked by referring to information in a Content-Type field in an HTTP header or the extension of the XML document.

As a result of the checking process in step S902, if the common XML parser 109 determines that the XML document is a text XML document, the process advances to step S904 via step S903. On the other hand, if the common XML parser 109 determines that the XML document is a binary XML document, the process advances to step S905 via step S903.

In step S904, the common XML parser 109 calls the function “SetDocument” of the text XML parser 105, and passes the XML document to the text XML parser 105. In this manner, the text XML parser 105 is controlled to parse this XML document.

On the other hand, in step S905 the common XML parser 109 calls the function “SetDocument” of the binary XML parser 106, and passes the XML document to the binary XML parser 106. In this way, the binary XML parser 106 is controlled to parse this XML document.

Each of the text XML parser 105 and binary XML parser 106 executes parsing processing of elements described in an XML document (structured document). That is, each of these parsers implements parsing processing according to the format of an XML document.

The functions “Read”, “GetNodeType”, “GetName”, and “Close” of the common XML parser 109 are wrappers which call the functions of the same names of the text XML parser 105 or binary XML parser 106 intact, and pass return values intact.

Details of the processing in steps S805 and S807 will be described below with reference to FIG. 10. FIG. 10 is a flowchart showing details of the processing in steps S805 and S807.

The CPU 101 checks in step S1002 which of the text XML parser 105 and binary XML parser 106 is controlled to execute parsing processing as a result of the checking process in step S902. As a result of checking, if the CPU 101 is currently controlling the text XML parser 105 to execute parsing processing, the process advances to step S1008. On the other hand, if the CPU 101 is currently controlling the binary XML parser 106 to execute parsing processing, the process advances to step S1003. In case of the XML document shown in FIG. 6, since the CPU 101 controls the binary XML parser 106 to execute parsing processing of this XML document, the process advances to step S1003.

The processes in step S1003 and subsequent steps will be described below separately in a case in which they are executed in step S805 and that in which they are executed in step S807.

A case will be explained first wherein the processes in step S1003 and subsequent steps are executed in step S805.

In step S1003, the CPU 101 executes the function “GetValueType” to acquire the parsed result of the binary XML parser 106. Since the function “GetValueAsString” is executed in step S805, the binary XML parser 106 acquires the type of the “name” tag, that is, the string type in case of the XML document shown in FIG. 6. Therefore, the CPU 101 acquires this string type as “type information” in step S1003.

In step S1004, the CPU 101 executes the function “GetStringValue” to acquire the parsed result of the binary XML parser 106. Since the function “GetValueAsString” is executed in step S805, the binary XML parser 106 acquires the contents of the “name” tag, that is, a character string “Alice” in case of the XML document shown in FIG. 6. Therefore, the CPU 101 acquires this character string “Alice” in step S1004.

The CPU 101 checks in step S1005 if the data type requested (accepted) by the function executed in step S805 (requested type) matches the type acquired in step S1003. As a result of this checking, if the two types match, the process jumps to step S1007. In case of the XML document shown in FIG. 6, since the data type requested by the function executed in step S805 is the string type, and the type acquired in step S1003 is also the string type, the CPU 101 determines that the two types match. In this case, in step S1007 the CPU 101 outputs the data (character string) acquired in step S1004 to the request source (helper application 111).

On the other hand, as a result of checking in step S1005, if the two types do not match, the process advances to step S1006. In step S1006, the CPU 101 converts the data type acquired in step S1004 into that of data requested by the function executed in step S805. After that, the CPU 101 outputs data, the type of which is converted in step S1006, to the request source in step S1007.

A case will be explained below wherein the processes in step S1003 and subsequent steps are executed in step S807.

In step S1003, the CPU 101 executes the function “GetValueType” to acquire the parsed result of the binary XML parser 106. Since the function “GetValueAsDouble” is executed in step S807, the binary XML parser 106 acquires the type of the “height” tag, that is, the double type in case of the XML document shown in FIG. 6. Therefore, the CPU 101 acquires this double type as “type information” in step S1003.

In step S1004, the CPU 101 executes the function “GetStringValue” to acquire the parsed result of the binary XML parser 106. Since the function “GetValueAsDouble” is executed in step S807, the binary XML parser 106 acquires the contents of the “height” tag, that is, a real number value “160.5” in case of the XML document shown in FIG. 6. Therefore, the CPU 101 acquires this real number value “160.5” in step S1004.

The CPU 101 checks in step S1005 if the data type requested by the function executed in step S807 (requested type) matches the type acquired in step S1003. As a result of this checking, if the two types match, the process jumps to step S1007. In case of the XML document shown in FIG. 6, since the data type requested by the function executed in step S807 is the double type, and the type acquired in step S1003 is also the double type, the CPU 101 determines that the two types match. In this case, in step S1007 the CPU 101 outputs the data (real number value) acquired in step S1004 to the request source (helper application 111).

On the other hand, as a result of checking in step S1005, if the two types do not match, the process advances to step S1006. In step S1006, the CPU 101 converts the data type acquired in step S1004 into that of data requested by the function executed in step S807. After that, the CPU 101 outputs data, the type of which is converted in step S1006, to the request source in step S1007.

The operation of the computer 100 executed when an XML document having a configuration shown in FIG. 7 is to be processed in place of the XML document shown in FIG. 6 will be described below. FIG. 7 shows a configuration example of an XML document to be processed by the computer 100. The XML document having the configuration shown in FIG. 7 is personal information data which describes the same contents as in the XML document shown in FIG. 6. However, the XML document shown in FIG. 6 is a binary XML document, while the XML document shown in FIG. 7 is a text XML document.

A tag 701 indicates that this XML document is of the text type.

Tags 702, 703, 705, 706, 708, and 709 respectively correspond to the tags 602, 603, 605, 606, 608, and 609 in FIG. 6, and have expressions unique to the text type.

Reference numerals 704 and 707 respectively denote a character string indicating the name of a person, and a real number value indicating the height, which are substantially the same as the contents 604 and 607 in FIG. 6, although they have different contents.

The differences from the aforementioned processes described using FIGS. 8 to 10 upon execution of the processes according to the flowcharts shown in FIGS. 8 to 10 for the XML document to be processed shown in FIG. 7 are as follows.

In step S902, the CPU 101 executes the format checking unit 108 to make it acquire the magic number (the contents of the tag 701 in FIG. 7) in the XML document opened in step S802. The common XML parser 109 acquires the magic number acquired by the format checking unit 108. The common XML parser 109 checks the format of the XML document using this acquired magic number. That is, the common XML parser 109 checks if the XML document is a text or binary XML document. The XML document shown in FIG. 7 is determined as a text XML document. Therefore, the process advances to step S904 via step S903. In step S904, the common XML parser 109 calls the function “SetDocument” of the text XML parser 105 and passes the XML document to the text XML parser 105. In this way, the common XML parser 109 controls the text XML parser 105 to parse this XML document.

The CPU 101 checks in step S1002 as a result of the checking process in step S902 which of the text XML parser 105 and binary XML parser 106 is controlled to execute parsing processing. In case of the XML document shown in FIG. 7, since the CPU 101 controls the text XML parser 105 to execute parsing processing of this XML document, the process advances to step S1008.

The processes in step S1008 and subsequent steps will be described below separately in a case in which they are executed in step S805 and that in which they are executed in step S807.

A case will be described first wherein the processes in step S1008 and subsequent steps are executed in step S805.

In step S1008, the CPU 101 executes the function “GetValue” to acquire the parsed result of the text XML parser 105. Since the function “GetValueAsString” is executed in step S805, the text XML parser 105 acquires the contents of the “name” tag, that is, a character string “Bob” in case of the XML document shown in FIG. 7. Therefore, the CPU 101 acquires this character string “Bob” in step S1008.

The CPU 101 checks in step S1009 if the data type requested by the function executed in step S805 (requested type) is a string type (string type) or “no designation”. As a result of checking, if the requested type is the string type or “no designation”, the process jumps to step S1007. In case of the XML document shown in FIG. 7, since the data type requested by the function executed in step S805 is the string type, the process jumps to step S1007. In step S1007, the CPU 101 outputs the data (character string) acquired in step S1008 to the request source (helper application 111).

On the other hand, as a result of checking in step S1009, if the requested type is neither the string type nor “no designation”, the process advances to step S1010. In step S1010, the CPU 101 executes the same process as in step S1006. After that, the CPU 101 outputs the data, the type of which is converted in step S1010, to the request source in step S1007.

A case will be explained below wherein the processes in step S1008 and subsequent steps are executed in step S807.

In step S1008, the CPU 101 executes the function “GetValue” to acquire the parsed result of the text XML parser 105. Since the function “GetValueAsDouble” is executed in step S807, the text XML parser 105 acquires the contents of the “height” tag, that is, a character string “175.3” in case of the XML document shown in FIG. 7. Therefore, the CPU 101 acquires this character string “175.3” in step S1008.

The CPU 101 checks in step S1009 if the data type requested by the function executed in step S807 (requested type) is a string type (string type) or “no designation”. As a result of checking, if the requested type is the string type or “no designation”, the process jumps to step S1007. On the other hand, as a result of checking in step S1009, if the requested type is neither the string type nor “no designation”, the process advances to step S1010.

In case of the XML document shown in FIG. 7, the data type requested by the function executed in step S807 is a double type (floating type), and it is neither the string type nor “no designation”. Therefore, in this case, the process advances to step S1010.

In step S1010, the CPU 101 converts the data type acquired in step S1008 to that of data requested by the function executed in step S807. As a result, the CPU 101 can acquire a float value “175.3” in the IEEE754 format.

After that, the CPU 101 outputs the data, the type of which is converted in step S1010, to the request source in step S1007.

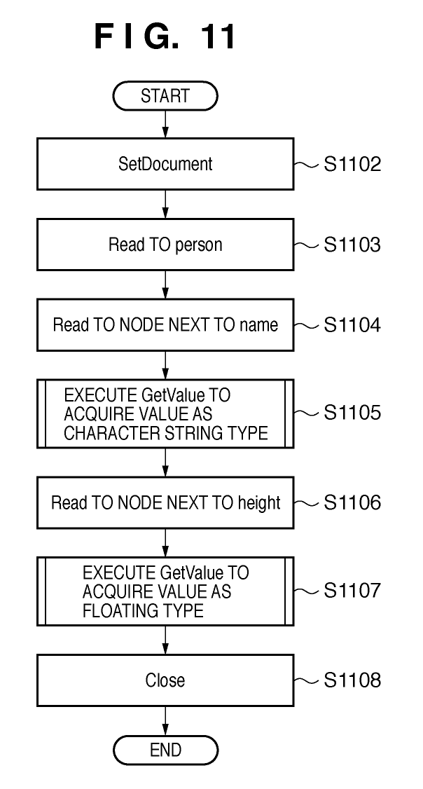

The operation of the legacy application 110 will be described below. Since the legacy application 110 originally does not target at a binary XML document, it is programmed using the APIs of the text XML parser 105. The processing executed by the computer 100 when this legacy application 110 handles personal information data corresponds to that according to the flowchart shown in FIG. 11.

FIG. 11 is a flowchart showing processing executed by the computer 100 when the legacy application 110 handles personal information data.

Steps S1102 to S1104, step S1106, and step S1108 are the same as steps S802 to S804, step S806, and step S808 shown in FIG. 8. The processes in steps S1105 and S1107 will be described below.

In steps S1105 and S1107, the CPU 101 acquires all node values using the function “GetValue”. Details of the processes in steps S1105 and S1107 correspond to those according to the flowchart shown in FIG. 10.

In this case, since the text XML parser 105 is used, the process advances from step S1002 to step S1008.

Since the CPU 101 executes the function “GetValue” to acquire the parsed result of the text XML parser 105 in step S1008, it acquires a character string “Alice” in step S1105 in case of the XML document shown in FIG. 6. Therefore, the CPU 101 acquires this character string “Alice” in step S1008.

Since the data type requested by the function executed in step S1105 (requested type) is a string type, the process jumps to step S1007 via step S1009. In step S1007, the CPU 101 outputs the data (character string) acquired in step S1008 to the request source (legacy application 110).

Since the CPU 101 executes the function “GetValue” to acquire the parsed result of the text XML parser 105 in step S1008, it acquires a character string “160.5” in step S1107 in case of the XML document shown in FIG. 6. Therefore, the CPU 101 acquires this character string “160.5” in step S1008.

Since the data type requested by the function executed in step S1107 (requested type) is a double type (floating type), the process advances to step S1010 via step S1009.

In step S1010, the CPU 101 converts the data type acquired in step S1008 into that of data requested by the function executed in step S1107. As a result, the CPU 101 can acquire a float value “160.5” in the IEEE754 format.

After that, the CPU 101 outputs this float value “160.5” to the request source in step S1007.

In this way, the legacy application 110 can acquire the values from the binary XML document.

When a text XML document is passed to the legacy application 110, since the common XML parser 109 does not execute any special processing, and simply behaves as a wrapper of the text XML parser 105, the legacy application 110 can normally acquire values.

As described above, according to this embodiment, since the common XML parser 109 can provide a function of normally acquiring values in combinations of the two types of applications and two types of formats of XML documents, that is, in all of a total of four cases.

Furthermore, when the helper application 111 handles a binary XML document, since no type conversion is executed during processing, efficient, high-speed processing can be attained. In this way, the application that uses XML documents supports high-speed processing using a binary XML document, and can also handle a text XML document.

Also, the application programmed for a text XML document can handle a binary XML document.

### Second Embodiment

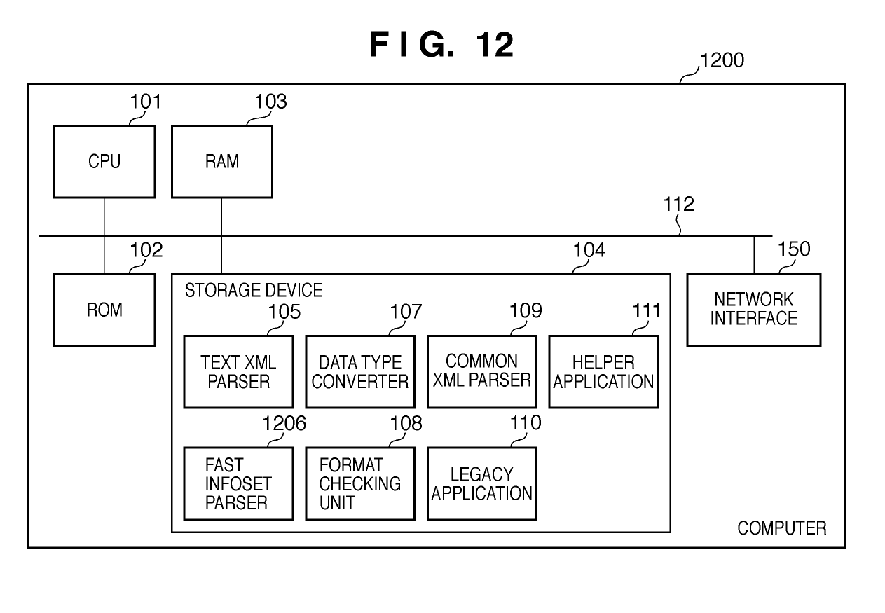

FIG. 12 is a block diagram showing the hardware arrangement of a computer 1200 which can be applied to a structured document processing apparatus according to this embodiment. The same reference numerals in FIG. 12 denote the same components as those in FIG. 1, and a repetitive description thereof will be avoided. That is, in the arrangement shown in FIG. 12, a Fast Infoset parser 1206 is saved in the storage device 104 in place of the binary XML parser 106 shown in FIG. 1.

The Fast Infoset parser 1206 parses an XML document in the Fast Infoset format as one of binary XML formats.

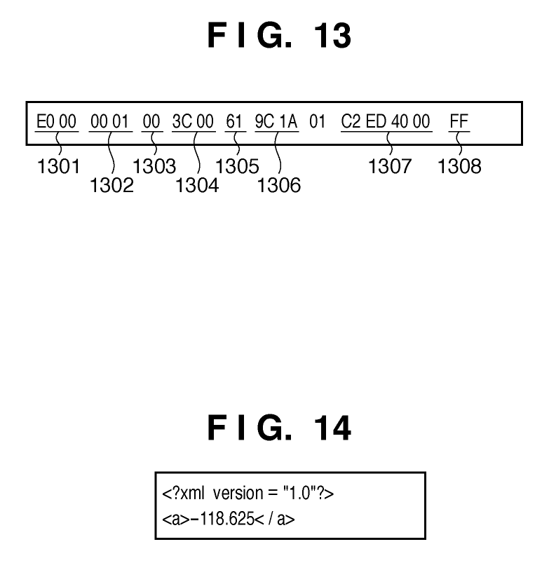

FIGS. 13 and 14 show an example of an XML document to be processed by the helper application 111. FIG. 14 shows a configuration example of a text XML document, and FIG. 13 shows a configuration example when the XML document shown in FIG. 14 is expressed in the Fast Infoset format.

Referring to FIG. 13, “E000” 1301 is a magic number, and indicates that this XML document has the Fast Infoset format.

“0001” 1302 is a Fast Infoset version, and the Fast Infoset version is “1” in this example.

“00” 1303 indicates the presence/absence of data as an option, and “00” means the absence of data.

“3C00” 1304 has many meanings since it has a meaning for each bit, and primarily means that the next node is an element. In addition, although “3C00” includes information of the presence/absence of an attribute, that of a nominal space name, the number of bytes of an element name, and the like, since they are related poorly to the gist of the description here, a detailed description thereof will not be given.

“61” 1305 is an element name “a” encoded by UTF-8.

Two bytes “9C1A” 1306 similarly have many meanings, and primarily mean that the next node is the contents of an element, and its value is of the floating type. In addition, these bytes include information of the number of bytes and the like.

“C2ED4000” 1307 is a float value “−118.625” encoded in the IEEE754 format.

First “F” of last “FF” 1308 represents the terminal end of an element, and next “F” represents the terminal end of a document. That is, the XML document shown in FIG. 13 has nearly the same meanings as the text XML document shown in FIG. 14. Not only the meanings of the document but also the order of appearance of nodes are the same.

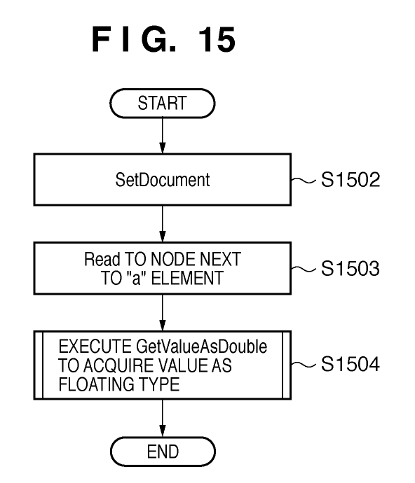

When the helper application 111 acquires the value of the “a” element shown in FIG. 13, the common XML parser 109 executes processing according to the flowchart shown in FIG. 15.

FIG. 15 is a flowchart showing processing executed by the computer 1200 when the helper application 111 acquires the value of the “a” element shown in FIG. 13.

In step S1502, the CPU 101 executes the function “SetDocument” to open the XML document shown in FIG. 13. Upon execution of the process in step S1502, the processing according to the flowchart shown in FIG. 9 starts as in the first embodiment. In the processing according to the flowchart shown in FIG. 9, the format checking process checks if the document format is the Fast Infoset format. This checking process can be attained by seeing if “E000” is described as the magic number. If “E000” is described as the magic number, the Fast Infoset parser 1206 is used; otherwise, the text XML parser 105 is used.

In step S1503, the CPU 101 executes the function “Read”, and executes the functions “GetNodeType” and “GetName” with respect to the current reference position advanced by that execution. The CPU 101 repetitively executes the function “Read” until the return value of the function “GetNodeType” is a start tag, and the return value of the function “GetName” is “a”. In the Fast Infoset format, since a byte string which represents the start of an element and that which represents the name of the element appears as in the text XML format, the first node is a start tag “a”.

In step S1504, the CPU 101 executes “GetValueAsDouble” to acquire the contents of the “a” tag, that is, “−118.625” as a real number value. Details of the process in step S1504 correspond to those according to the flowchart shown in FIG. 10.

That is, since the Fast Infoset parser 1206 is used, the CPU 101 receives the type information of data from the Fast Infoset parser 1206 in step S1003. Since the Fast Infoset parser 1206 determines based on “9C1A” 1306 in FIG. 13 that the value of this data is a float, it returns a double type as type information. In step S1004, the CPU 101 acquires the value of that type, that is, “−118.625”.

The CPU 101 checks in step S1005 if the data type requested by the function executed in step S1504 (requested type) matches the type acquired in step S1003. As a result of checking, if the two types match, the process jumps to step S1007. In case of the XML document shown in FIG. 13, since the data type requested by the function executed in step S1504 is the double type, and the type acquired in step S1003 is also the double type, the CPU 101 determined that the two types match. In this case, the CPU 101 outputs the data (real number value) acquired in step S1004 to the request source (helper application 111) in step S1007.

In this way, data can be passed to the application without any wasteful conversion.

Note that even the text XML document shown in FIG. 14 used as an object to be processed can be processed in the same manner as in the first embodiment.

As described above, a structured document processing apparatus which can support both an XML document in the conventional text XML format and that in the Fast Infoset format, and can execute processing without any wasteful data type conversion can be implemented.

Note that communication devices that can use XML documents such as a mobile phone, copying machine, and the like can be used as the computers 100 and 1200.

### Other Embodiments

The objects of the present invention can be achieved as follows. That is, a recording medium (or storage medium) that records program codes of software required to implement the functions of the aforementioned embodiments is supplied to a system or apparatus. That storage medium is a computer-readable storage medium, needless to say. A computer (or a CPU or MPU) of that system or apparatus reads out and executes the program codes stored in the recording medium. In this case, the program codes themselves read out from the recording medium implement the functions of the aforementioned embodiments, and the recording medium that records the program codes constitutes the present invention.

When the computer executes the readout program codes, an operating system (OS) or the like, which runs on the computer, executes some or all of actual processes based on instructions of these program codes. The present invention also includes a case in which the functions of the aforementioned embodiments are implemented by these processes.

Furthermore, assume that the program codes read out from the recording medium are written in a memory equipped on a function expansion card or function expansion unit which is inserted into or connected to the computer. After that, a CPU or the like equipped on the function expansion card or unit executes some or all of actual processes based on instructions of these program codes, thereby implementing the functions of the aforementioned embodiments.

When the present invention is applied to the recording medium, that recording medium stores program codes corresponding to the aforementioned flowcharts.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-226694 filed Aug. 31, 2007, which is hereby incorporated by reference herein in its entirety.

What is claimed is:

1. A structured document processing apparatus for processing a structured document, comprising:
an acquisition unit which acquires a format of a structured document;
a parsing unit which parses the structured document by a parsing method according to the format acquired by the acquisition unit;
a unit which accepts a request of acquiring an element described in the structured document to have a designated type;
a determination unit which determines whether or not a type of the element parsed by the parsing unit matches the designated type; and
an output unit which outputs the element to a request source when the determination unit determines a match, and outputs the element to the request source after the type of the element is converted to the designated type when the determination unit determines a mismatch.

2. The apparatus according to claim 1, wherein the parsing unit comprises a binary XML parser and a text XML parser,
when the format acquired by the acquisition unit is binary XML, the parsing unit parses the structured document using the binary XML parser, and
when the format acquired by the acquisition unit is text XML, the parsing unit parses the structured document using the text XML parser.

3. The apparatus according to claim 1, wherein the parsing unit comprises a Fast Infoset parser and a text XML parser,
when the format acquired by the acquisition unit is a Fast Infoset format, the parsing unit parses the structured document using the Fast Infoset parser, and
when the format acquired by the acquisition unit is text XML, the parsing unit parses the structured document using the text XML parser.

4. A structured document processing method to be executed by a structured document processing apparatus for processing a structured document, comprising:
an acquisition step of acquiring a format of a structured document;
a parsing step of parsing the structured document by a parsing method according to the format acquired in the acquisition step;
a step of accepting a request of acquiring an element described in the structured document to have a designated type;
a determination step of determining whether or not a type of the element parsed in the parsing step matches the designated type; and
an output step of outputting the element to a request source when a match is determined in the determination step, and outputting the element to the request source after the type of the element is converted to the designated type when a mismatch is determined in the determination step.

5. A computer-readable storage medium storing a program for making a computer execute a structured document processing method according to claim 4.
